(19) United States
(12) Patent Application Publication
(10) Pub. No.: US 2026/0339433 A1
(43) Pub. Date: Oct. 29, 2026

(54) Input Interface for Head-Mounted Devices Based on Gaze Directed to Body Parts Associated with Values

(71) Applicant: Apple Inc., Cupertino, CA (US)

(72) Inventors: Amit Pratap Rane, Santa Clara, CA (US); Shannon L. Gardiner, Berkeley, CA (US); Chiraag Juvekar, San Carlos, CA (US); Karan Sanghi, San Carlos, CA (US)

(21) Appl. No.: 19/650,766

(22) Filed: Apr. 17, 2026

Related U.S. Application Data
(60) Provisional application No. 63/792,992, filed on Apr. 23, 2025.

(51) Int. Cl. G06F 3/01; G06F 1/16; G06T 7/70

(52) U.S. Cl. CPC G06F 3/013; G06F 1/163; G06F 3/016; G06F 3/017; G06T 7/70; G06T 2207/30196

(57) ABSTRACT

Devices, systems, and methods that recognize user input based on a user’s fingertips or other body parts being associated with particular values. For example, the fingertips on the user’s left hand may correspond to the numbers 1, 2, 3, 4, 5 respectively. Implementations disclosed herein may involve techniques that detect an interaction, for example, by detecting that the user has sequentially gazed at (or used the other hand to touch) the fingertips corresponding to the values of a numerical code. The techniques disclosed herein may be utilized for various types of devices including, but not limited to, on a smart glasses device or other head-mounted device (HMD) that has limited or no display capabilities, but that has sensing capabilities, e.g., capabilities for sensing the user’s body part positions (e.g., where fingertips are) and/or user gaze directions (e.g., at which fingertip the user is gazing at a given time).

### CROSS-REFERENCE TO RELATED APPLICATIONS

This Application claims the benefit of U.S. Provisional Application Serial No. 63/792,992 filed Apr. 23, 2025, which is incorporated herein in its entirety.

### TECHNICAL FIELD

The present disclosure generally relates to assessing user interactions with electronic devices and more particularly relates to assessing interactions that involve hand and body activity, gaze, voice and/or other user activity.

### BACKGROUND

Existing user interaction systems may be improved with respect to facilitating interactions based on user activities.

### SUMMARY

Various implementations disclosed herein include devices, systems, and methods that recognize user input based on a user’s fingertips or other body parts being associated with particular values. For example, the fingertips on the user’s left hand may correspond to the numbers 1, 2, 3, 4, 5 respectively. Implementations disclosed herein may involve techniques that detect an interaction, for example, by detecting that the user has sequentially gazed at (or used the other hand to touch) the fingertips in an order corresponding to the values of a numerical code. The techniques disclosed herein may be utilized for various types of devices including, but not limited to, on a smart glasses device or other head-mounted device (HMD) that has limited or no display capabilities, but that has sensing capabilities, e.g., capabilities for sensing the user’s body part positions (e.g., where fingertips are) and/or user gaze directions (e.g., at which fingertip the user is gazing at a given time). Audio, haptic, or visual (e.g., LED) feedback may be provided when input is recognized, e.g., each time a user gazes at a fingertip, audio feedback may identify the corresponding value as having been inputted. The techniques may detect a sequence of gaze direction interactions to different body/hand regions to enable the user to enter codes, provide an unlock sequence, answer binary (e.g., yes/no) questions or multiple-choice questions, etc.

In some implementations, a processor performs a method by executing instructions stored on a computer readable medium. The method may be performed at an HMD having a processor. The method involves detecting three-dimensional (3D) positions of each body part of a set of multiple body parts (e.g., fingertips) of a user. The 3D positions may be determined based on data from a first sensor (e.g., an outward-facing camera) of the HMD. Each body part of the set of multiple body parts is associated with a different value, e.g., number, letter, word, phrase, etc. There may be predetermined relationships between particular body parts and particular values that are determined automatically, by default, manually, or otherwise. The method involves detecting a gaze direction of a user based on data from an eye-facing sensor (e.g., an inward-facing camera) of the HMD. The method involves identifying a gaze of the user directed to a first body part of the set of body parts based on the 3D positions of the set of body parts and the gaze direction. The method involves generating input to the HMD based on identifying the gaze of the user being directed to the first body part, wherein the input corresponds to a first value associated first body part.

Some implementations recognize user input based on a user touching a particular body part of a set of body parts associated with predetermined values, e.g., the user using a finger on one hand to touch the fingertips of the other hand to enter values associated with those fingertips as input. For example, the user may use the finger of the right hand to touch the fingertips on their left hand, each corresponding to the numbers 1, 2, 3, 4, 5 respectively. The user may sequentially touch different fingertips to enter a numerical code, as an example. The technique may be used on a smart glasses device or another HMD that has limited or no display capabilities. Audio, haptic, or visual (e.g., LED) feedback may be provided when input is recognized. The techniques may be used to detect user activity corresponding to a user engaging in a sequence of touch interactions to different body/hand regions to enter codes, provide an unlock sequence, answer binary/multiple-choice questions, etc.

In some implementations, a processor performs a method by executing instructions stored on a computer readable medium. The method may be performed at a HMD having a processor. The method involves detecting 3D positions of each body part of a set of multiple body parts (e.g., fingertips) of a user. The 3D positions may be determined based on one or more sensors (e.g., an outward-facing camera) of the HMD. Each body part of the set of multiple body parts may be associated with a different value. There may be predetermined relationships between particular body parts and particular values that are determined automatically, by default, manually, or otherwise. The method involves tracking a position of a finger of the user based on the data from the one or more sensors. The method involves identifying a touch by a user, e.g., contact between the finger and a first body part of the set of multiple body parts. The method involves generating input to the HMD based on identifying the touch by the user between the finger and the first body part, wherein the input corresponds to a first value associated first body part.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment in accordance with some implementations.

FIG. 2 illustrates detection of user’s hand by the electronic device of FIG. 1, in accordance with some implementations.

FIG. 3 illustrates detection of user’s hand providing a gesture to initiate an interaction mode in which interactions are identified based on interactions with portions of the hand associated with different respective values, in accordance with some implementations.

FIG. 4 illustrates portions of the user’s hand associated with different respective values, in accordance with some implementations.

FIGS. 5 A-D illustrate a sequence of gaze-based user interactions with the different portions of the user’s hand to provide a sequence of values, in accordance with some implementations.

FIG. 6 illustrates a touch-based user interaction with a portion of the user’s hand corresponding to a value, in accordance with some implementations.

FIG. 7 is a flowchart illustrating a method for generating input based on identifying a gaze-based interaction with a portion of a user’s hand associated with a value, in accordance with some implementations.

FIG. 8 is a flowchart illustrating a method for generating input based on identifying a touch-based interaction with a portion of a user’s hand associated with a value, in accordance with some implementations.

FIG. 9 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

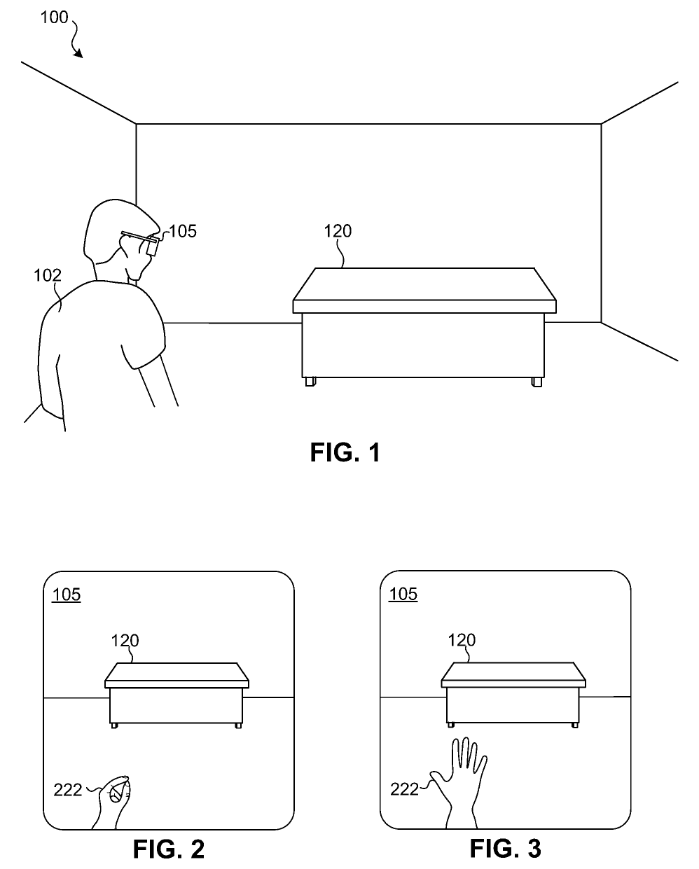

FIG. 1 illustrates an exemplary electronic device 105 operating in a physical environment 100. In the example of FIG. 1, the physical environment 100 is a room that includes a desk 120. The electronic device 105 is a head-mounted device (HMD) in this example. The electronic device may include limited or no visual display capabilities, e.g., it may include LEDs, indicator lights, etc. that provide binary (off/on) indications but not include a pixel-based display capable of displaying images. The techniques disclosed herein are particularly useful to devices with limited or no display capabilities such as many smart glasses-type devices that are display-less. However, the techniques are also applicable to devices that do include visual display capabilities, including devices capable of displaying images, extended reality (XR) views, passthrough video, etc.

The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to enhance the experience of the user 102. The information about the user 102 may be used to determine 3D positions of the user’s fingertips and other body parts and/or to identify interactions with such body parts.

In one example, one or more outward-facing sensors (e.g., first sensors) on the electronic device 105 capture sensor data from which the 3D positions of user body parts are identified and one or more inward-facing sensors (e.g., eye-facing sensors) on the electronic device 105 capture sensor data from which a gaze direction is identified. The user gazing at a particular body part (e.g., fingertip) may be identified by determined an intersection between such a gaze direction and a respective body part (e.g., fingertip).

In another example, one or more outward-facing sensors (e.g., first sensors) on the electronic device 105 capture sensor data from which the 3D positions of user body parts are identified. The touching a particular body part (e.g., touching a finger of one hand with a particular fingertip of the other hand) may be identified by determining an intersection between body parts based on their 3D positions and/or relative 3D movements.

FIG. 2 illustrates detection of user’s hand by the electronic device 105 of FIG. 1. FIG. 2 illustrates the user’s hand as viewed from a viewpoint of the user 102. For example, if the electronic device 105 is a pair of smart glasses, the user may see such a view 105 through the lenses of the smart glasses. In this example, a user hand 222 has a configuration (e.g., pinching) that is determined based on sensor data obtained via the electronic device 105. For example, one or more image and/or depth sensors on the electronic device 105 may provide sensor data from which a representation of the hand’s 3D shape over time is estimated. Such a representation may, for example, be a skeletal representation of the hand having joint representations and or bone representations. In another example, a hand representation comprises a set of 3D positions corresponding to portions of the hand (e.g., fingertips) and a pinch is identified when a thumb fingertip is determined to be touching another fingertip (e.g., having positions within a predetermined threshold distance of one another). Detection of the user hand configuration (e.g., pinching) may provide input to the electronic device 105 and/or trigger an interaction mode.

In one example, if the user gazes at an object in the physical environment 100 while putting their hand in the hand configuration (e.g., performing a pinching gesture), the device recognizes an interaction targeted towards that object. For example, if the user were to gaze at desk 120 and perform a pinching gesture, the electronic device may provide a response, e.g., identifying the corresponding object with an audible message (“desk,” etc.) or prompt (e.g., would you like to (1) identify this desk or (2) initiate a user experience involving this desk?”, etc.).

FIG. 3 illustrates detection of user’s hand providing a gesture to initiate an interaction mode in which interactions are identified based on interactions with portions of the hand associated with different respective values. As in FIG. 2, the user hand 222 has a configuration (e.g., palm flat facing user) that is determined based on sensor data obtained via the electronic device 105 and such a configuration may be determined based on generating a representation of the hand based on the sensor data and determining whether the hand satisfies criteria associated with the configuration, e.g., are the fingers extended at least a threshold amount?, is the orientation of the palm of the hand oriented in a direction facing the user within a threshold angular offset?, etc. Based on determining that the user hand is exhibiting the configuration (e.g., palm flat facing user), the electronic device 105 responds, in this example, by initiating an interaction mode in which interactions are identified based on interactions with portions of the hand associated with different respective values.

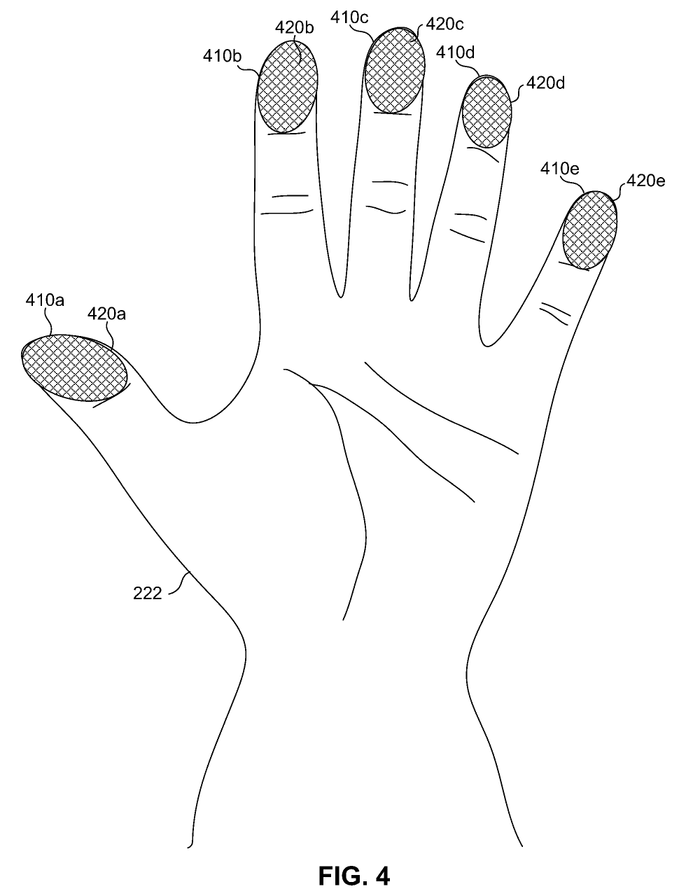

FIG. 4 illustrates portions 410a-e of the user’s hand 222 associated with different respective values. In this example, regions of space 420a-e define 2D or 3D areas that are associated with those portions 410a-e of the user’s hand 222. Such regions of space 420a-e may be based on identifying the configuration of the hand 222 and/or the boundaries of the outer surfaces of the hand 222. In one example, this involves using sensor data (e.g., images, depth data, etc.) to determine a hand skeleton and one or more parameters that correspond to hand thickness. An algorithm or machine learning model may interpret sensor data (e.g., images of the user hands) and/or utilize information about the user (e.g., information from a prior user hand enrollment procedure) to determine parameters that define the size, shape, or other characteristics of the outer surfaces of the user’s hand. For example, a hand skeleton provides information about center point locations of each fingertip and parameters corresponding to finger size are used to define the size and/or shapes of fingertip regions centered around those center point locations. The regions of space 420a-e may have determined 3D or 3D areas that can be used to assess a user’s interactions, e.g., determine whether the user is gazing at the fingertip 410a associated with region 420a, determine whether the user touching fingertip 410b associated with region 410b with a finger of the other hand, etc.

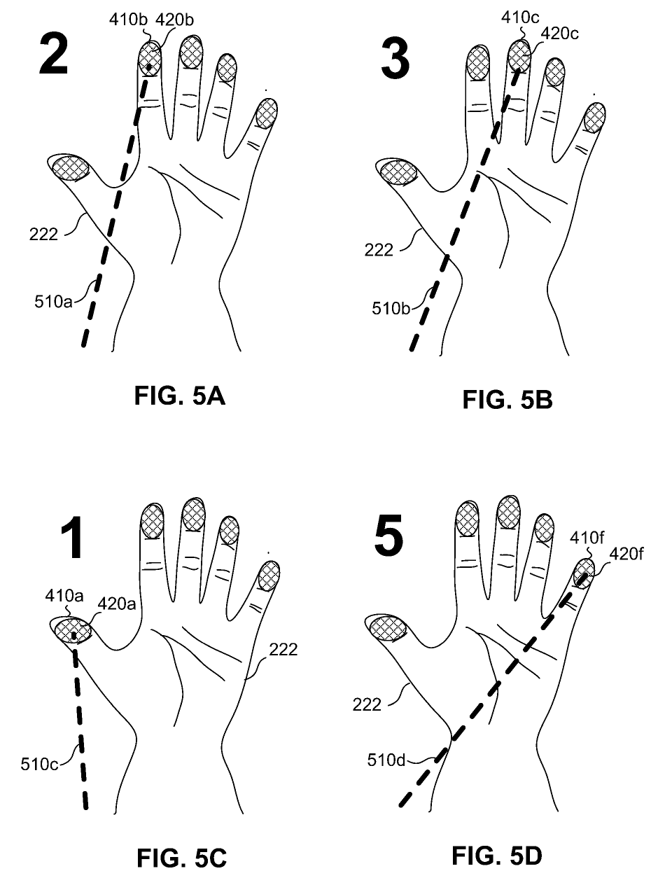

FIGS. 5A-D illustrate a sequence of gaze-based user interactions with the different portions of the user’s hand to provide a sequence of values. In this example, as shown in FIG. 5A, the user 102 first gazes at fingertip 410b. The device 105 detects the gaze direction 510a of the user 102 and that the gaze direction 510a intersects region 420b. Region 420b is associated with fingertip 410b which, in this example, is associated with the value “2”. In this way the device 105 interprets the user’s action – holding their hand out with palm facing the user while gazing at fingertip 410b – as input providing the value “2”.

In this example, as shown in FIG. 5B, the user 102 next gazes at fingertip 410c. The device 105 detects the gaze direction 510b of the user 102 and that the gaze direction 510b intersects region 420c. Region 420c is associated with fingertip 410c which, in this example, is associated with the value “3”. In this way, the device 105 interprets the user’s action – holding their hand out with palm facing the user while gazing at fingertip 410c – as input providing the value “3”.

In this example, as shown in FIG. 5C, the user 102 next gazes at fingertip 410a. The device 105 detects the gaze direction 510c of the user 102 and that the gaze direction 510c intersects region 420a. Region 420a is associated with fingertip 410a which, in this example, is associated with the value “1”. In this way, the device 105 interprets the user’s action – holding their hand out with palm facing the user while gazing at fingertip 410a – as input providing the value “1”.

In this example, as shown in FIG. 5D, the user 102 next gazes at fingertip 410f. The device 105 detects the gaze direction 510d of the user 102 and that the gaze direction 510d intersects region 420f. Region 420f is associated with fingertip 410f which, in this example, is associated with the value “5”. In this way, the device 105 interprets the user’s action – holding their hand out with palm facing the user while gazing at fingertip 410f – as input providing the value “5”.

The sequence of user interactions illustrated in FIGS. 5A-D – the user holding their hand out with palm facing the user while sequentially gazing at fingertip 410b, then fingertip 410c, the fingertip 410a, then fingertip 410f is recognized as input providing the value sequence “2315,” which may be a passcode, etc.

In some implementations, as illustrated in FIGS. 5A-D, different parts of the user’s body are associated with different values, and the user 102 interacts with those different portions to provide input to an electronic device providing one or more of those values. The interactions can be performed in a sequence to provide a corresponding sequence of values, as illustrated in FIGS. 5A-D. Such a sequence can have any length, e.g., number of sequential values. A user may provide input signaling the end of entry of additional values for a sequence in various aways, e.g., by turning their hand so that the hand so that the palm is no longer facing the user, providing an audible command “stop input,” etc.

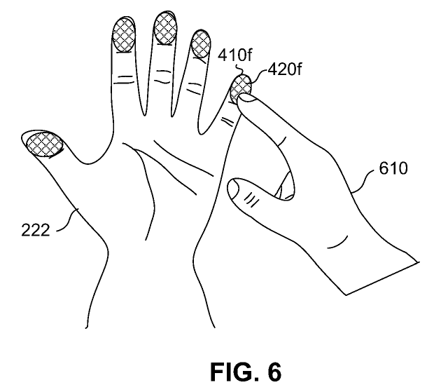

FIG. 6 illustrates a touch-based user interaction with a portion of the user’s hand corresponding to a value. In this example, as shown in FIG. 6, the user 102 uses hand 610 to touch fingertip 410f. The device 105 detects the hand 610 of the user 102 and hand 610 is touching the fingertip 410f, e.g., by determining that a 3D position of a representation of the hand 610 (e.g., a skeleton and/or information about outer surface location of hand 610) intersects or is within a predetermined distance threshold of a 3D position of region 420f. Region 420f is associated with fingertip 410f which, in this example, is associated with the value “5”. In this way, the device 105 interprets the user’s action – holding their hand out with palm facing the user while touching fingertip 410f – as input providing the value “5”.

Various implementations disclosed herein provide systems and methods that may use gaze to determine interactions with user body parts associated with values (e.g., as illustrated in FIGS. 5A-D), touch to determine interactions with body parts associated with values (e.g., as illustrated in FIG. 6), or a combination of gaze and touch to determine interactions with user body parts associated with values, e.g., the user gazing at one fingertip, touching another fingertip, etc. In some implementations, gaze-based interactions are the default interaction mode and touch-based interactions are enabled as an accessibility feature and/or in use cases in which the electronic device has low confidence in gaze tracking information.

Various implementations disclosed herein may be utilized on devices that have limited display capabilities, e.g., HMDs such as certain smart glasses that lack displays capable of displaying user interface icons or other elements with respect to which a user might otherwise interact. Such devices may leverage sensor information about the user (e.g., where the user’s body parts are within 3D space) and associations of user information about the user (e.g., associations of fingertips or other body parts with particular values) to enable useful input modalities. Users may interact with body parts to provide numerical codes, text strings, sequences of elements, etc. Devices with limited display capabilities may additionally leverage information about user gaze or eye condition, e.g., determining when the user is looking at body parts associated with particular values. This may involve recognizing when the user looks at a body part and provides an additional interaction, e.g. blinking, providing an audible command, etc. Various implementations utilize sensors on an HMD (e.g., outward and/or inward facing cameras) to recognize user activity associated with certain values to be provided as input.

In various implementations, different sections of the user’s hand are designated as target points/regions for the user to gaze at, e.g., finger tips, to provide corresponding input values. The values associated with such body parts may be fixed or variable. In various implementations, a user in enabled to customize or otherwise change the values associated with particular body parts, e.g., providing a custom mapping of what each fingertip represents. In some implementations, other hand regions such as interphalangeal creases, phalanges, regions on the user’s palm, etc., are used instead of or in addition to fingertips.

In some implementations, the target regions associated with particular body parts are adjusted (e.g., in size, shape, position, etc.) based on current conditions. For example, the target regions may be adjusted based on the width between the user’s fingers, e.g., how far (if at all) the fingers are spread apart. As an example, larger targets may be used when the user’s fingers are spread farther apart. Environment conditions (e.g., lighting determined via an ambient light sensor (ALS)) may be used to adjust target regions.

Various types of feedback may be provided as a user provides input using interactions with body parts associated with values. Such feedback may involve one or more of audible feedback, haptic feedback, and/or visual feedback. In implementations in which the electronic device has limited display capabilities, visual feedback may be provided by visual indicators (e.g., LEDs) that the device may have, e.g., an LED blinking and/or showing a particular color when a user input is recognized where a number of blinks or color corresponds to an inputted value.

In some implementations, the electronic device 105 facilitates a user provides input using interactions with body parts associated with values by providing spatially aware guidance. For example, the electronic device may detect the user looking at target zone and intensity of sound of feedback as the user continues to look at the zone for a period of time - until the threshold time at which the input is recognized. Thus, if a user inadvertently looks at a particular target zone, the feedback will begin and signal the user to look away before the input is recognized. In other words, such feedback may be used to signal to user how the user’s activity is being interpreted or about to be interpreted so the user can ensure that only intentional activity is recognized as input.

Various implementations disclosed herein present a series of options (e.g., option 1, option 2, option 3, option 4, and option 5) to a user and the user selects an option by interacting with a body part that corresponds to the option. For example, the device may audible present a set of five options and the user may select one by gazing at or touching a fingertip associated with the corresponding option. For example, the first option may be associated with fingertip 410a, the second option may be associated with fingertip 410b, etc. of FIG. 4. In one use case, a user is enabled to complete a form by providing user interface input by selecting values for different forms on the field from sets of options corresponding to the different fields on the form. The form may identify the options for one or more of the fields (e.g., providing a set of options for eye color) and/or the device may identify the values for one or more of the fields (e.g., recognizing that the field is a name field and presenting the user’s first name and last name for the user to choose from for the field).

This input techniques described herein may provide a relatively private way for a user to interact with the electronic device in a public area since the user may be able to interact with limited or no audible commands that might be overheard by others and the user’s gaze at a particular fingertip or other body part may not be readily associated with the values to which the body parts at which the gaze is directed correspond.

In various implementations the electronic device instructs the user to adjust their body to facilitate more confidence in user interactions with body parts associated with values. For example, if the user’s fingertips are associated with values, the user may be instructed to spread their fingers apart to improve confidence in gaze and/or touch interactions with particular fingertips.

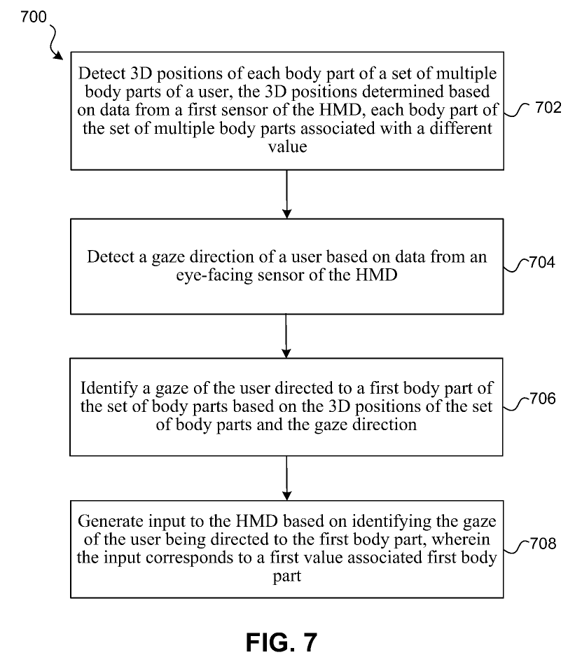

FIG. 7 is a flowchart illustrating a method 700 for generating input based on identifying a gaze-based interaction with a portion of a user’s hand associated with a value. In some implementations, a device such as electronic device 105 performs method 700. In some implementations, method 700 is performed on a mobile device, desktop, laptop, HMD, or server device. The method 700 is performed by processing logic, including hardware, firmware, software, or a combination thereof. In some implementations, the method 700 is performed on a processor executing code stored in a non-transitory computer-readable medium (e.g., a memory).

At block 702, the method 700 involves detecting 3D positions of each body part of a set of multiple body parts (e.g., fingertips) of a user, the 3D positions determined based on data from a first sensor (e.g., outward-facing camera) of the HMD, each body part of the set of multiple body parts associated with a different value. The multiple body parts may correspond to portions of a hand of the user. At least one of the multiple body parts may corresponds to fingertip on a hand of the user. In some implementations, the multiple body parts correspond to five fingertips on a hand of the user. the multiple body parts correspond to one or more regions on a palm of a hand of the user. In some implementations, the multiple body parts correspond one or more interphalangeal creases of a hand of the user. In some implementations, the multiple body parts correspond one or more phalanges of a hand of the user.

The method 700 may involve tracking a user hand position in 3D space based on sensor data. This may involve obtaining user position data corresponding to a 3D position of a portion (e.g., finger/hand) of a user in the 3D space. The user position data may be obtained based on sensor data (e.g., image sensor, depth sensor data, motion sensor data, etc.) and may provide a path of the portion of the user over a time period. In one example, the user position data may be a skeleton representation of the user generated periodically, e.g., 30 fps, based on outward facing image/depth sensors on an HMD. Such user position data may provide a path of a portion of the skeleton (e.g., a finger skeleton portion). In some implementations, the portion of the user corresponds to a point on or in a finger of the user. The portion of the user may correspond to a point on or in a hand of the user. The user position data may correspond to a position within a skeleton representation of the user that is generated periodically, e.g., at multiple points in time during a period of time.

At block 704, the method 700 involves detecting a gaze direction of a user based on an eye-facing sensor (e.g., an inward-facing camera) of the HMD. In one implementation, the first sensor is an outward-facing camera and eye-facing sensor is an inward-facing camera different than the outward-facing camera.

At block 706, the method 700 involves identifying a gaze of the user directed to a first body part of the set of body parts based on the 3D positions of the set of body parts and the gaze direction.

At block 708, the method 700 involves generating input to the HMD based on identifying the gaze of the user being directed to the first body part, wherein the input corresponds to a first value associated first body part.

The method 700 may involve initiating a body-part-based gaze input mode in which the input is generated based on identifying the gaze of the user being directed to the multiple body parts. Such a body-part-based gaze input mode may be initiated based on detecting a user activity, e.g., detecting that a user palm is exposed in a region of 3D space in front of the HMD.

The method 700 may involve providing feedback based on identifying the gaze of the user being directed to the first body part, the feedback comprising an audible, haptic, or LED indication.

In some implementations, the 3D positions of the body parts are each associated with one of multiple target regions, the target regions each having a size and a shape, wherein different inputs are generated based on detecting that the user is gazing at different target regions. The different inputs may be detected based on detecting that the gaze direction of the user intersects a respective one of the target regions. A sequence of input values may be detected based on detecting a sequence in which the gaze direction of the user intersects the target regions.

The size and/or shape of the target regions may be determined based on an environmental condition. The size and/or shape of the target regions may be determined based on relative positioning of the multiple body parts (e.g., how far apart the fingers are spaced).

The method 700 may involve detecting that the relative positioning of the multiple body parts does not satisfy a condition and, based on the detecting, providing an instruction for the user to adjust the positioning of the multiple body parts to satisfy the condition.

The method 700 may involve receiving input to the HMD. Such input to the HMD may comprises a multi-value numerical code used to authenticate the user, the code comprising a sequence of input values detected based on detecting a sequence in which the gaze direction of the user intersects multiple target regions associated with the multiple body parts, etc. The input to the HMD may comprise a binary response (e.g., yes/no) in which: a first input value is identified when the gaze direction intersects a first target region associated with a first body part; and a second input value is identified when the gaze direction intersects a second target region associated with a second body part. The input to the HMD may comprise a selection of one of a set of commonly used values specific to the user (e.g., first name, last name, etc.).

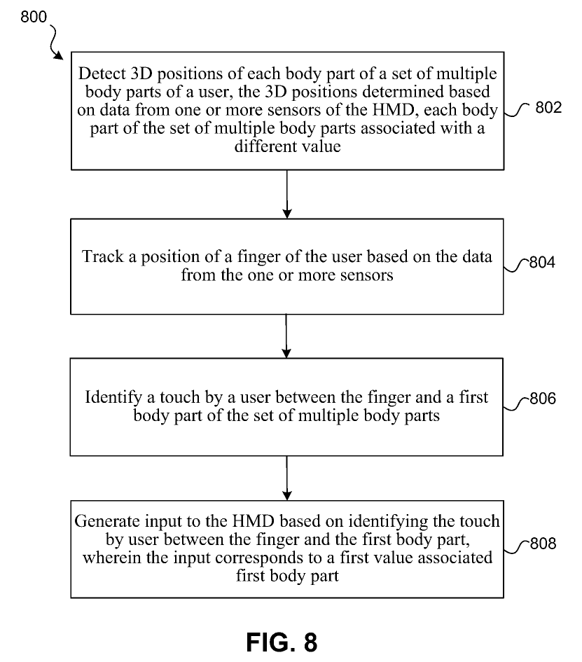

FIG. 8 is a flowchart illustrating a method 800 for generating input based on identifying a touch-based interaction with a portion of a user’s hand associated with a value. In some implementations, a device such as electronic device 105 performs method 800. In some implementations, method 800 is performed on a mobile device, desktop, laptop, HMD, or server device. The method 800 is performed by processing logic, including hardware, firmware, software, or a combination thereof. In some implementations, the method 800 is performed on a processor executing code stored in a non-transitory computer-readable medium (e.g., a memory).

At block 802, the method 800 involves detecting 3D positions of each body part of a set of multiple body parts (e.g., fingertips) of a user, the 3D positions determined based on data from one or more sensors (e.g., outward-facing camera) of the HMD, each body part of the set of multiple body parts associated with a different value. The multiple body parts may correspond to portions of a hand of the user. At least one of the multiple body parts may corresponds to fingertip on a hand of the user. In some implementations, the multiple body parts correspond to five fingertips on a hand of the user. the multiple body parts correspond to one or more regions on a palm of a hand of the user. In some implementations, the multiple body parts correspond one or more interphalangeal creases of a hand of the user. In some implementations, the multiple body parts correspond one or more phalanges of a hand of the user.

At block 804, the method 800 may involve tracking a position of a finger of the user based on the data from the one or more sensors. The method 800 may track a position of one or both hands of the user in the 3D space based on sensor data. This may involve obtaining user position data corresponding to a 3D position of a portion (e.g., finger/hand) of a user in the 3D space. The user position data may be obtained based on sensor data (e.g., image sensor, depth sensor data, motion sensor data, etc.) and may provide a path of the portion of the user over a time period. In one example, the user position data may be a skeleton representation of the user generated periodically, e.g., 30 fps, based on outward facing image/depth sensors on an HMD. Such user position data may provide a path of a portion of the skeleton (e.g., a finger skeleton portion). In some implementations, the portion of the user corresponds to a point on or in a finger of the user. The portion of the user may correspond to a point on or in a hand of the user. The user position data may correspond to a position within a skeleton representation of the user that is generated periodically, e.g., at multiple points in time during a period of time.

At block 806, the method 800 involves identifying a touch by a user between the finger and a first body part of the set of multiple body parts.

At block 808, the method 800 involves generating input to the HMD based on identifying the touch by user between the finger and the first body part, wherein the input corresponds to a first value associated first body part.

The method 800 may involve initiating a body-part-based touch input mode in which the input is generated based on identifying the user touching the multiple body parts. Such a body-part-based touch input mode may be initiated based on detecting a user activity, e.g., detecting that a user palm is exposed in a region of 3D space in front of the HMD.

The method 800 may involve providing feedback based on identifying the user touching the first body part, the feedback comprising an audible, haptic, or LED indication.

In some implementations, the 3D positions of the body parts are each associated with one of multiple target regions, the target regions each having a size and a shape, wherein different inputs are generated based on detecting that the user is touching different target regions. The different inputs may be detected based on detecting that the touch corresponds to a location of a respective one of the target regions. A sequence of input values may be detected based on detecting a sequence in which the finger of the user touches the target regions.

The size and/or shape of the target regions may be determined based on an environmental condition. The size and/or shape of the target regions may be determined based on relative positioning of the multiple body parts (e.g., how far apart the fingers are spaced).

The method 800 may involve detecting that the relative positioning of the multiple body parts does not satisfy a condition and, based on the detecting, providing an instruction for the user to adjust the positioning of the multiple body parts to satisfy the condition.

The method 800 may involve receiving input to the HMD. Such input to the HMD may comprises a multi-value numerical code used to authenticate the user, the code comprising a sequence of input values detected based on detecting a sequence in which the user touches multiple target regions associated with the multiple body parts, etc. The input to the HMD may comprise a binary response (e.g., yes/no) in which: a first input value is identified when the finger touches a first target region associated with a first body part; and a second input value is identified when the finger touches a second target region associated with a second body part. The input to the HMD may comprise a selection of one of a set of commonly used values specific to the user (e.g., first name, last name, etc.).

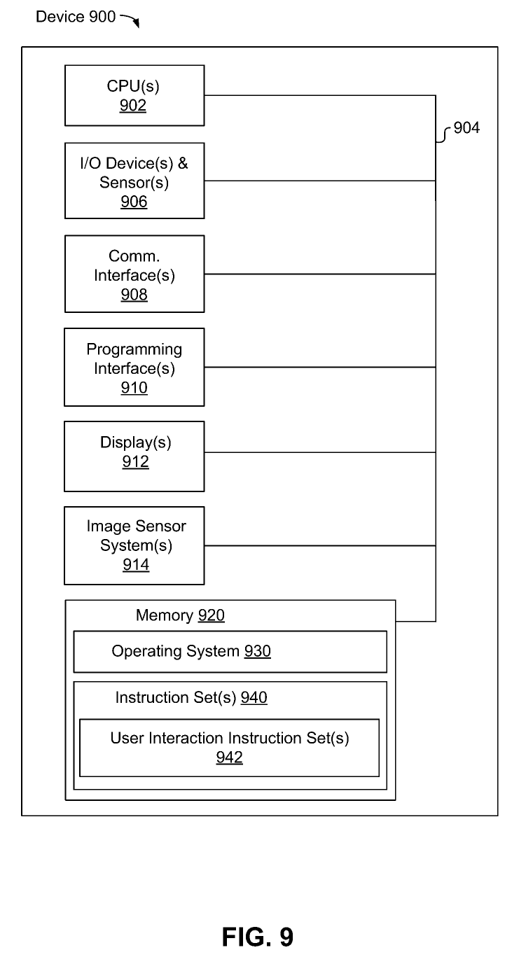

FIG. 9 is a block diagram of electronic device 900. Device 900 illustrates an exemplary device configuration for electronic device 105. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 900 includes one or more processing units 902 (e.g., microprocessors, ASICs, FPGAs, GPUs, CPUs, processing cores, and/or the like), one or more input/output (I/O) devices and sensors 906, one or more communication interfaces 908 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 910, one or more output device(s) 912, one or more interior and/or exterior facing image sensor systems 914, a memory 920, and one or more communication buses 904 for interconnecting these and various other components.

In some implementations, the one or more communication buses 904 include circuitry that interconnects and controls communications between system components. In some implementations, the one or more I/O devices and sensors 906 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 912 include one or more displays configured to present a view of a 3D environment to the user. In some implementations, the one or more displays 912 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 900 includes a single display. In another example, the device 900 includes a display for each eye of the user.

In some implementations, the one or more output device(s) 912 include one or more audio producing devices. In some implementations, the one or more output device(s) 912 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener’s brain into interpreting sounds as if the sounds occurred at the point(s) in the 3D environment (e.g., from one or more particular sound sources) even though the actual sounds may be produced by speakers in other locations. The one or more output device(s) 912 may additionally or alternatively be configured to generate haptics.

In some implementations, the one or more image sensor systems 914 are configured to obtain image data that corresponds to at least a portion of a physical environment. For example, the one or more image sensor systems 914 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 914 further include illumination sources that emit light, such as a flash. In various implementations, the one or more image sensor systems 914 further include an on-camera image signal processor (ISP) configured to execute a plurality of processing operations on the image data.

The memory 920 includes high-speed random-access memory, such as DRAM, SRAM, DDR RAM, or other random-access solid-state memory devices. In some implementations, the memory 920 includes non-volatile memory, such as one or more magnetic disk storage devices, optical disk storage devices, flash memory devices, or other non-volatile solid-state storage devices. The memory 920 optionally includes one or more storage devices remotely located from the one or more processing units 902. The memory 920 comprises a non-transitory computer readable storage medium.

In some implementations, the memory 920 or the non-transitory computer readable storage medium of the memory 920 stores an optional operating system 930 and one or more instruction set(s) 940. The operating system 930 includes procedures for handling various basic system services and for performing hardware dependent tasks. In some implementations, the instruction set(s) 940 include executable software defined by binary information stored in the form of electrical charge. In some implementations, the instruction set(s) 940 are software that is executable by the one or more processing units 902 to carry out one or more of the techniques described herein.

The instruction set(s) 940 include user interaction instruction set(s) 942 configured to, upon execution, identify and/or interpret user activities as described herein. The instruction set(s) 940 may be embodied as a single software executable or multiple software executables.

Although the instruction set(s) 940 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user’s experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a head-mounted device (HMD) having a processor:
detecting three-dimensional (3D) positions of each body part of a set of multiple body parts of a user, the 3D positions determined based on data from a first sensor of the HMD, each body part of the set of multiple body parts associated with a different value;
detecting a gaze direction of a user based on an eye-facing sensor of the HMD;
identifying a gaze of the user directed to a first body part of the set of body parts based on the 3D positions of the set of body parts and the gaze direction; and
generating input to the HMD based on identifying the gaze of the user being directed to the first body part, wherein the input corresponds to a first value associated with the first body part.

2. The method of claim 1, wherein the first sensor is an outward-facing camera and eye-facing sensor is an inward-facing camera different than the outward-facing camera.

3. The method of claim 1, wherein multiple body parts correspond to portions of a hand of the user.

4. The method of claim 1, wherein at least one of the multiple body parts corresponds to fingertip on a hand of the user.

5. The method of claim 1, wherein the multiple body parts correspond to five fingertips on a hand of the user.

6. The method of claim 1, wherein the multiple body parts correspond to one or more regions on a palm of a hand of the user.

7. The method of claim 1, wherein the multiple body parts correspond one or more interphalangeal creases or phalanges of a hand of the user.

8. The method of claim 1 further comprising initiating a body-part-based gaze input mode in which the input is generated based on identifying the gaze of the user being directed to the multiple body parts, wherein the body-part-based gaze input mode is initiated based on detecting that a user palm is exposed in a region of 3D space in front of the HMD.

9. The method of claim 1 further comprising providing feedback based on identifying the gaze of the user being directed to the first body part, the feedback comprising an audible, haptic, or LED indication.

10. The method of claim 1, wherein the 3D positions of each body part are associated with one of multiple target regions, the target regions each having a size and a shape, wherein different inputs are generated based on detecting that the user is gazing at different target regions.

11. The method of claim 10, wherein the different inputs are detected based on detecting that the gaze direction of the user intersects a respective one of the target regions.

12. The method of claim 10, wherein a sequence of input values is detected based on detecting a sequence in which the gaze direction of the user intersects the target regions.

13. The method of claim 10, wherein the size or shape of the target regions is determined based on an environmental condition.

14. The method of claim 10, wherein the size or shape of the target regions is determined based on relative positioning of the multiple body parts.

15. The method of claim 10 further comprising:
detecting that the relative positioning of the multiple body parts does not satisfy a condition; and
based on the detecting, providing an instruction for the user to adjust the positioning of the multiple body parts to satisfy the condition.

16. The method of claim 1, wherein the input to the HMD comprises a multi-value numerical code used to authenticate the user, the code comprising a sequence of input values detected based on detecting a sequence in which the gaze direction of the user intersects multiple target regions associated with the multiple body parts.

17. The method of claim 1, wherein the input to the HMD comprises a binary response in which:
a first input value is identified when the gaze direction intersects a first target region associated with a first body part; and
a second input value is identified when the gaze direction intersects a second target region associated with a second body part.

18. The method of claim 1, wherein the input to the HMD comprises a selection of one of a set of commonly used values specific to the user.

19. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
detecting three-dimensional (3D) positions of each body part of a set of multiple body parts of a user, the 3D positions determined based on data from a first sensor of the HMD, each body part of the set of multiple body parts associated with a different value;
detecting a gaze direction of a user based on an eye-facing sensor of the HMD;
identifying a gaze of the user directed to a first body part of the set of body parts based on the 3D positions of the set of body parts and the gaze direction; and
generating input to the HMD based on identifying the gaze of the user being directed to the first body part, wherein the input corresponds to a first value associated with the first body part.

20. A non-transitory computer-readable storage medium storing program instructions executable via one or more processors to perform operations comprising:
detecting three-dimensional (3D) positions of each body part of a set of multiple body parts of a user, the 3D positions determined based on data from a first sensor of the HMD, each body part of the set of multiple body parts associated with a different value;
detecting a gaze direction of a user based on an eye-facing sensor of the HMD;
identifying a gaze of the user directed to a first body part of the set of body parts based on the 3D positions of the set of body parts and the gaze direction; and
generating input to the HMD based on identifying the gaze of the user being directed to the first body part, wherein the input corresponds to a first value associated with the first body part.
